(19) United States
(12) Patent Application Publication
(10) Pub. No.: US 2012/0093227 A1
(43) Pub. Date: Apr. 19, 2012

(54) DATA COMPRESSION METHOD AND DATA COMPRESSION DEVICE

(75) Inventor: Kiyonori MORIOKA, Kawasaki (JP)

(73) Assignee: FUJITSU LIMITED, Kawasaki-shi (JP)

(21) Appl. No.: 13/269,731

(22) Filed: Oct. 10, 2011

(30) Foreign Application Priority Data
Oct. 14, 2010 (JP) 2010-231649

(51) Int. Cl. H04N 7/32

(52) U.S. Cl. 375/240.16; 375/E07.243

(57) ABSTRACT

A data compression method includes: dividing image data corresponding to one frame into a plurality of blocks; detecting a motion vector of a first block of the plurality of blocks; setting a flag to the first block based on the motion vector; performing a first reduction process on the first block; and performing a second reduction process on a second block of the plurality of blocks.

### CROSS-REFERENCE TO RELATED APPLICATIONS

This application claims the benefit of priority from Japanese Patent Application No. 2010-231649 filed on Oct. 14, 2010, the entire contents of which are incorporated herein by reference.

### BACKGROUND

1. Field

Embodiments discussed herein are related to a data compression method and a data compression device.

2. Description of Related Art

A video recording device including a transcoder (translator) records digital TV broadcasting such as digital terrestrial TV broadcasting. A transcoder encodes moving image data with a high compression rate in order to record the moving image data on a recording medium such as a hard disk device or a Blu-ray Disc.

A transcoder may reduce compressed data by reducing an image of each of frames included in moving image data. Resolution of an image may be restored by means of super-resolution techniques.

Related art is disclosed in Japanese Patent No. 3190220, Japanese laid-open Patent Publication No. 2008-33914 or a non-patent document, i.e., S. C. Park, M. K. Park and M. G. Kang, “Super-resolution image reconstruction: a technical overview”, IEEE Signal Processing Magazine, 26(3):21-36, May 2003.

### SUMMARY

According to one aspect of the embodiments, a data compression method comprising: dividing image data corresponding to one frame into a plurality of blocks; detecting a motion vector of a first block of the plurality of blocks; setting a flag to the first block based on the motion vector; performing a first reduction process on the first block; and performing a second reduction process on a second block of the plurality of blocks.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary data compression system.

FIG. 2 illustrates an exemplary block identifying circuit and an exemplary resolution converting circuit.

FIGS. 3A and 3B illustrate an exemplary setting of a flag.

FIG. 4 illustrates an exemplary low resolution image production process.

FIGS. 5A and 5B illustrate exemplary functions.

FIGS. 6A and 6B illustrate exemplary filter coefficients.

FIG. 7 illustrates an exemplary calculation of a filter coefficient.

FIG. 8 illustrates an exemplary encoding process.

FIG. 9 illustrates an exemplary resolution converting circuit.

FIGS. 10A and 10B illustrate an exemplary resolution converting process.

FIG. 11 illustrates an exemplary data compression device and an exemplary data restoring device.

FIG. 12 illustrates an exemplary block identifying circuit.

### DESCRIPTION OF EMBODIMENTS

According to super-resolution techniques, pixels of a frame to be processed are interpolated using a plurality of reduced frame images positioned temporally prior to and behind the frame to be processed. For example, since pixel values included in a reduced frame image change when an object moves, an image is restored by an interpolation process.

In a sequence of a moving image of an object which does not move much, pixel values included in temporally consecutive reduced frame images may not change much.

For example, super-resolution techniques may be applied to an image including a stationary object by changing an imaging system for every input image, for example, by changing a reading start position for a thinning or mixing process when generating a reduced image. A uniform displacement may be given in a frame of every input image. As a change of a pixel value according to a displacement is used for an interpolation process, a still image having a resolution value higher than that of an imaging sensor may be generated.

Information for an interpolation process is generated based on a uniform displacement periodically provided in a frame. If a compression encoding process of a moving image such as a transcoder includes an interpolation process, a periodic vibration may appear in a moving image restored from recorded re-compressed encoded data. If a transcoder encodes a reduced image to which a uniform displacement is given, a periodic displacement and aliasing of a high frequency component causes compression efficiency to drop, thereby moving image data being insufficiently compressed.

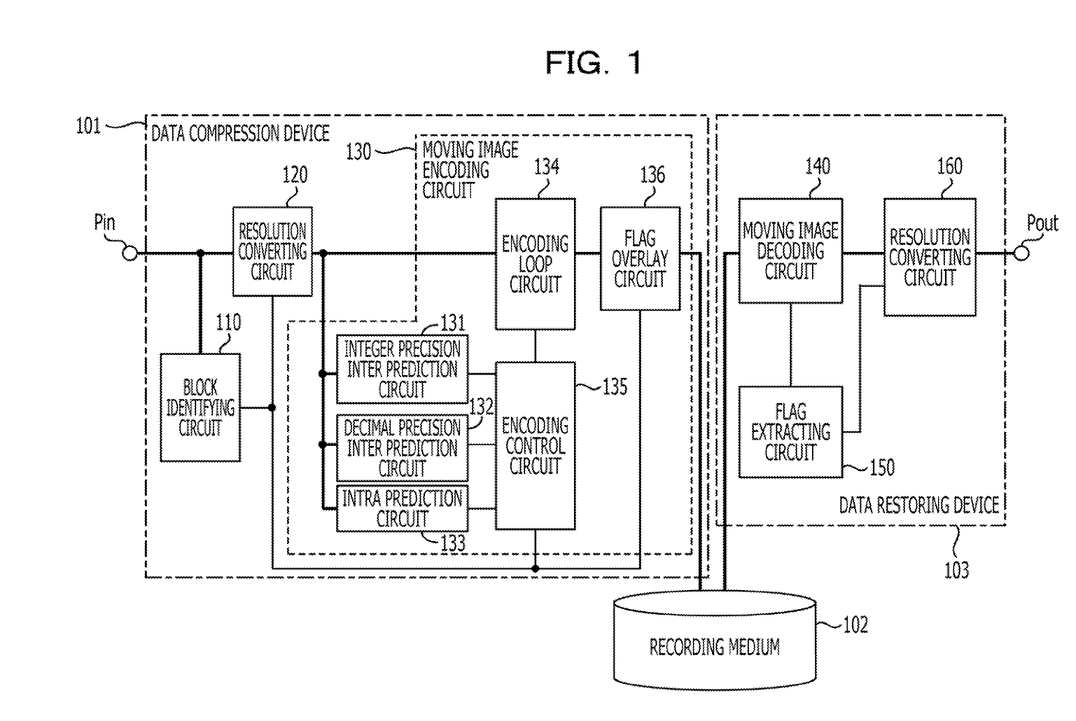

FIG. 1 illustrates an exemplary data compression system. The data compression system illustrated in FIG. 1 may include a transcoder. The data compression system includes a data compression device 101, a recording medium 102 and a data restoring device 103.

The data compression device 101 illustrated in FIG. 1 includes a block detecting circuit 110, a resolution converting circuit 120 and a moving image encoding circuit 130. The data compression device 101 is provided with moving image data to be compressed via an input port Pin.

The block detecting circuit 110 and the resolution converting circuit 120 detects each of a plurality of blocks, which are generated by dividing each of frames of the moving image data, and converts each of the blocks into a low resolution image. The block detecting circuit 110 detects whether image data of each of the blocks is of an object having a movement. The block identifying circuit 110 supplies a detecting result to the resolution converting circuit 120 and the moving image encoding circuit 130 as a flag to be set to each of the blocks. The resolution converting circuit 120 resolution-converts by using different space filters depending upon the flags set to the blocks.

The moving image encoding circuit 130 moving-image-encodes a sequence of low resolution images generated by the resolution converting circuit 120, for example, based on the H.264 standard. The encoded data obtained by moving-image-encoding may be recorded on a recording medium such as a hard disk device or a Blu-ray Disc device.

The moving image encoding circuit 130 illustrated in FIG. 1 includes an integer precision inter prediction circuit 131, a decimal precision inter prediction circuit 132, an intra prediction circuit 133, an encoding loop circuit 134, an encoding control circuit 135 and a flag overlay circuit 136.

The integer precision inter prediction circuit 131, the decimal precision inter prediction circuit 132, the intra prediction circuit 133 and the encoding loop circuit 134 are provided with a low resolution image generated by the resolution converting circuit 120. These circuits process a low resolution image on a macro block basis. The encoding control circuit 135 controls the prediction processes of the integer precision inter prediction circuit 131, the decimal precision inter prediction circuit 132 and the intra prediction circuit 133 or the encoding process of the encoding loop circuit 134 based on a flag corresponding to a macro block to be processed. The flag overlay circuit 136 overlays stream data generated by the encoding loop circuit 134 with information of the flags of the respective macro blocks, for example. Stream data including the data of the flags may be stored in the recording medium 102 illustrated in FIG. 1.

The data restoring device 103 illustrated in FIG. 1 restores a high resolution moving image from compressed moving image data compressed by the data compression device 101. The data restoring device 103 includes a moving image decoding circuit 140, a flag extracting circuit 150 and a resolution converting circuit 160. The moving image decoding circuit 140 is provided with compressed moving image data read from the recording medium 102. The moving image decoding circuit 140 decodes based on the H.264 standard so as to restore a sequence of low resolution images. The resolution converting circuit 160 is provided with the sequence of the restored low resolution images. The flag extracting circuit 150 may extract the information of a flag, with is overlaid in the stream data, in parallel with the decoding process. The resolution converting circuit 160 is provided with the extracted flag information. The resolution converting circuit 160 carries out a super-resolution process on each of the frames included in the sequence of the low resolution images by using data of a restored reference image so as to generate a high resolution image. The generated high resolution image may be output to a display device which is not illustrated, etc. via an output port Pout.

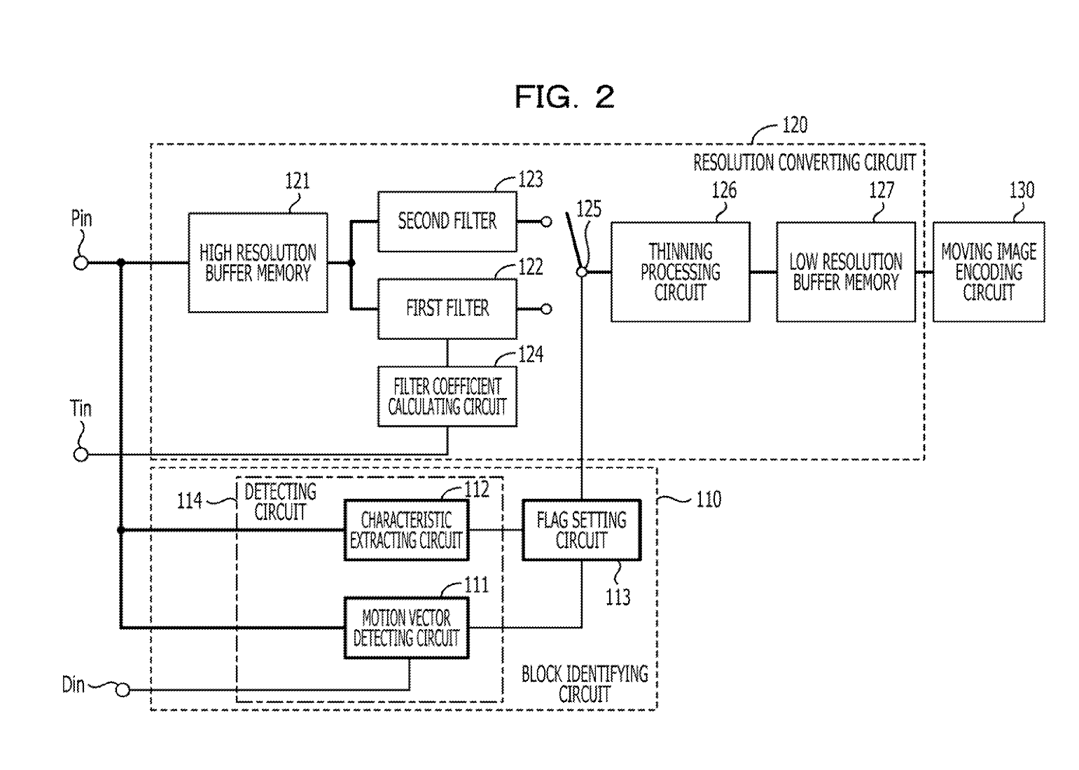

FIG. 2 illustrates an exemplary block identifying circuit and an exemplary resolution converting circuit. The block identifying circuit 110 and the resolution converting circuit 120 illustrated in FIG. 2 may be included in the data compression system illustrated in FIG. 1. The data compression device may generate a low resolution image.

The block identifying circuit 110 includes a motion vector detecting circuit 111, a characteristic extracting circuit 112 and a flag setting circuit 113. A reference image for detecting a motion vector is supplied to the motion vector detecting circuit 111 via an input port Din. An image of a frame positioned immediately before a frame to be compressed may be used as a reference image.

The motion vector detecting circuit searches for a portion of a reference image similar to a block of a frame to be compressed. The motion vector detecting circuit detects a motion vector for each of the blocks based on the search result. The flag setting circuit 113 may be provided with a motion vector.

The characteristic extracting circuit 112 calculates an index indicating flatness or a characteristic amount including edge strength, etc. for each of blocks of a frame to be compressed. The characteristic extracting circuit 112 may calculate an index indicating flatness and edge strength as a characteristic amount of each of blocks, or may calculate either one of them. Equation (1), e.g., gives an index S indicating flatness. A brightness value B(x, y) indicates a brightness value of each of pixels in a block. A variable Bay indicates an average of brightness values in the block. The index S may be calculated based on RGB components when a pixel value including the RGB components is used.

S=Σ(B(x,y)−Bₐᵥ)² (2)

The index S indicating flatness and the edge strength indicate whether a block image has details. The characteristic extracting circuit 112 may calculate a characteristic amount indicating whether each of blocks has details for detecting a motion vector. A characteristic amount is supplied to the flag setting circuit 113.

The flag setting circuit 113 detects whether a block image stands still based on whether a motion vector corresponding to an individual block and a characteristic amount of an image satisfy a certain condition. If the motion vector is not longer than a threshold Thv, e.g., the flag setting circuit 113 may detect that a motion vector condition is satisfied. When one pixel of a low resolution image is generated, the threshold Thy may be determined based on a range of a high resolution image that a pixel value is reflected on. For example, when one pixel of a low resolution image is generated with reference to a range of three pixels times three pixels of a high resolution image, the threshold Thy may be set to a value corresponding to one to two pixels.

For example, if the index S indicating flatness is equal to or more than a threshold Ths, the flag setting circuit 113 may detect that a characteristic amount condition is satisfied. The flag setting circuit 113 may detect that a condition based on the characteristic amount is satisfied when the edge strength is equal to or more than a threshold Tha. When the condition based on the characteristic amount is satisfied, a motion vector detected as to a block may be reliable.

FIG. 2 illustrates a detecting circuit 114 including a motion vector detecting circuit 111 and a characteristic extracting circuit 112. The detecting circuit 114 detects a reliable motion vector for each of blocks. If a motion vector condition and a characteristic amount condition are satisfied, the flag setting circuit 113 may detect that a block image is stationary. The flag setting circuit 113 may set a value indicating “true” to a flag of a block detected as being stationary, and may set a value indicating “false” to a flag of another block.

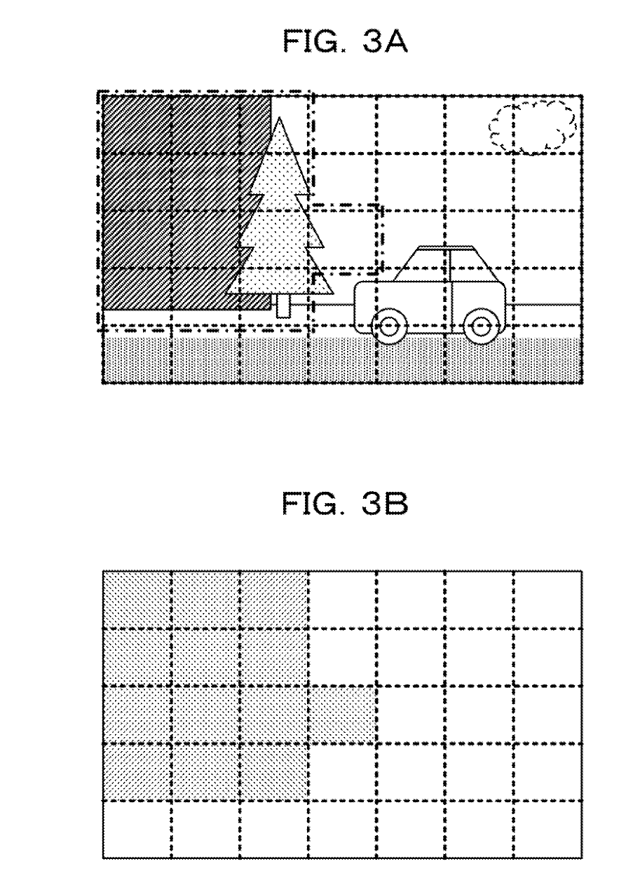

FIGS. 3A and 3B illustrate an exemplary setting of a flag. An image of one frame illustrated in FIGS. 3A and 3B is partitioned into vertically five blocks times horizontally seven blocks. The respective blocks are separated by bold dotted lines. A frame may be partitioned into vertically M blocks times horizontally N blocks. The symbols M and N may be integers.

FIG. 3A illustrates a frame to be compressed. The image to be compressed illustrated in FIG. 3A includes a moving vehicle and a tree and a wall, which are stationary, for a background. An area surrounded by dot-and-dash lines in FIG. 3A includes blocks including objects which are at stationary such as a tree or a wall having regular pattern and have details. Each of the blocks included in the area surrounded by the dot-and-dash lines may be detected by the block detecting circuit 110 as being stationary. Since a motion vector condition is not satisfied regarding a block including an image having the moving vehicle, the block may not be detected as still. Since a characteristic amount condition is not satisfied regarding a block including a street, the sky or a cloud, the block may not be detect by the block identifying circuit 110 as being statuinary. FIG. 3B illustrates detecting results for the respective blocks illustrated in FIG. 3A. A dot meshing in FIG. 3B indicates a block detected as being stationary, for example, a block corresponding to a flag indicating “true”.

The resolution converting circuit 120 carries out a resolution converting process based on a flag set by the block identifying circuit 110.

The resolution converting circuit 120 illustrated in FIG. 2 includes a high resolution buffer memory 121, a first filter 122, a second filter 123, a filter coefficient calculating circuit 124, a switch 125, a thinning processing circuit 126 and a low resolution buffer memory 127. The frame data to be compressed is supplied to the first filter 122 and the second filter 123 via the high resolution buffer memory 121. A filter coefficient having a second transmission characteristic is set to the second filter 123. A filter coefficient of the first filter 122 may be calculated by the filter coefficient calculating circuit 124 based on another first transmission characteristic. The filter coefficient calculating circuit 124 calculates a filter coefficient by using, e.g., the number of a frame to be compressed or a position of a block in the frame to be compressed. In FIG. 2, the frame number and position data of a pixel in a block are supplied to the filter coefficient calculating circuit 124 via an input port Tin.

The switch 125 provides the thinning processing circuit 126 with an output of the first filter 122 or an output of the second filter 123 selectively based on a flag set in accordance with a block. In a block which is detected as being stationary, e.g., a block corresponding to a flag indicating “true”, an output of the first filter 122 is supplied to the thinning processing circuit 126. In a block which is detected as not being stationary, e.g., a block corresponding to a flag indicating “false”, an output of the second filter 123 is supplied to the thinning processing circuit 126. The thinning processing circuit 126 reduces image data input via the switch 125 in a certain ratio so as to generate a low resolution image. The moving image encoding circuit 130 is provided with the low resolution image via the low resolution buffer memory 127. The resolution converting circuit 120 illustrated in FIG. 2 may perform a reduction process by using the first filter 122 and the second filter 123.

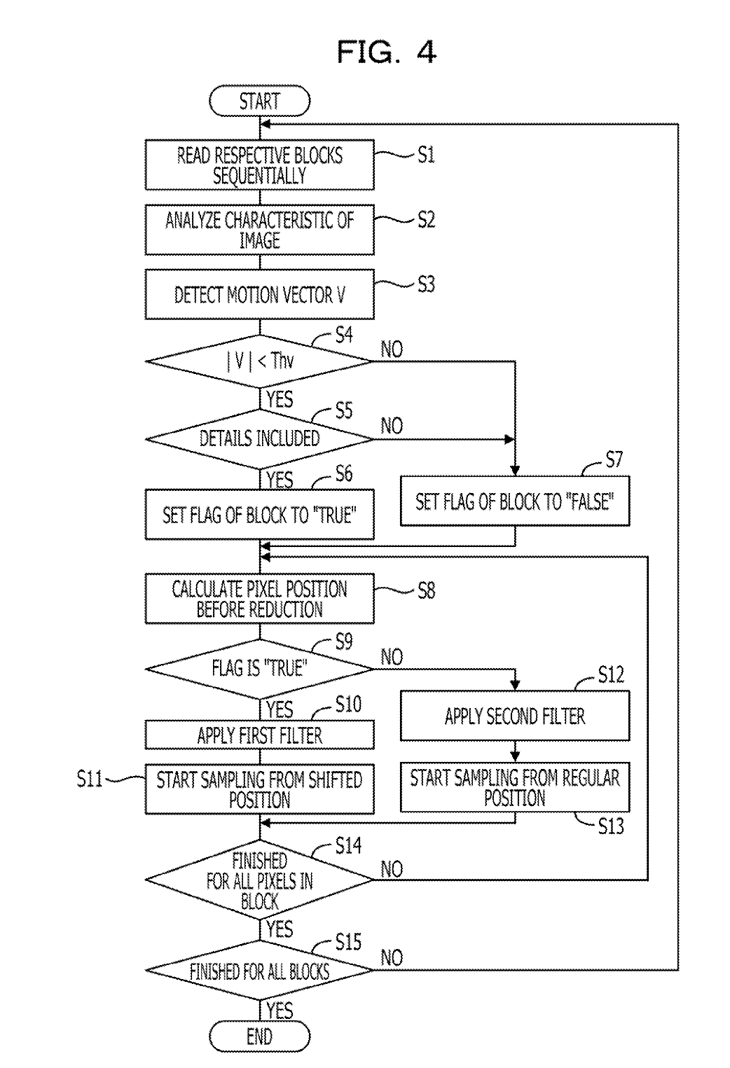

FIG. 4 illustrates an exemplary low resolution image production process. Operations S2-S7 may correspond to a operations which are performed by the block identifying circuit. Operations S8-S14 may be performed by the resolution converting circuit 120 illustrated in FIG. 2.

Blocks included in a frame to be compressed are sequentially read at an operation S1. A characteristic amount of a block image is extracted and a motion vector V of the block image is detected in operations S2 and S3. The characteristic extracting circuit 112 or the motion vector detecting circuit 111 illustrated in FIG. 2 may perform the operation S2 or S3. The motion vector V and the characteristic amount are detected based on a condition in operations S4 and S5 The flag setting circuit 113 illustrated in FIG. 2 may perform the operation S4 or S5. If the condition is satisfied in the operations S4 and S5, a value indicating “true” is set to a block flag in an operation S6. If the condition is not satisfied in at least one of the operations S4 and S5 in the least, a value indicating “false” is set to the block flag in an operation S7. The flag setting circuit 113 may perform the operation S6 or S7.

A position of a pixel included in a high resolution image before the reduction corresponding to a pixel of a low resolution image is calculated in an operation S8. The resolution converting circuit 120 illustrated in FIG. 2 may perform the operation S8. A flag set to a block including a pixel is referred to. If at least one flag is detected as having a value indicating “true” in an operation S9, a sampling process may be started from a position apart from a regular sampling starting position by variations (px, py) in an operation S11. For example, the reducing processing circuit 126 may be provided with an output of the first filter 122 illustrated in FIG. 2, and may perform the sampling process. If at least one of pixels included in a high resolution image before the reduction is included in a block which is detected as being stationary, e.g., a block corresponding to a flag indicating “true”, a pixel value of a reduced image may be determined based on sampling at a first phase apart from a regular phase by the variations (px, py). The variations (px, py) applied to the sampling starting position may be determined, e.g., based on coordinates of a pixel of a high resolution image corresponding to a pixel of a low resolution image or the frame number.

If the flag is detected as not indicating “true” in the operation S9, e.g., a pixel of a high resolution image before an reduction is included in a block which is detected as not being stationary, e.g., a block corresponding to a flag indicating “false”, a sampling process is started from the regular sampling starting position in an operation S13. The reducing processing circuit 126 may be provided with an output of the second filter 123 illustrated in FIG. 2 via the switch 125. The reducing processing circuit 126 illustrated in FIG. 2 may start the sampling process from the regular sampling starting position. If all pixels of a high resolution image before the reduction are included in a block detected as not being stationary, e.g., a block corresponding to a flag indicating “false”, a pixel value of a reduced image is determined depending upon sampling at a second phase of the regular sampling starting position.

In an operation S14, whether the low resolution image production process has been finished for all the pixels in the block read in the operation S1 or not is checked. When all the pixels are not processed, the process returns to the operation S8 and a pixel of the reduced image is processed. If all the pixels are processed, whether the process has been finished for all blocks included in the frame to be compressed or not is checked in an operation S15. When all blocks are not processed, the process returns to the operation S1 and a new block is read. The operations S1-S15 are repeated. If all the blocks are processed, the process ends.

The operation S10 or S11 may be performed on a block detected as being stationary, e.g., a block corresponding to a flag indicating “true”. For example, the first filter 122 having the first transmission characteristic and the reducing processing circuit 126 may carry out a filtering process and a sampling process at the shifted first phase, respectively. The operation S12 or S13 may be performed on a block which is detected as being stationary, e.g., a block corresponding to a flag indicating “false”. For example, the second filter 123 having the second transmission characteristic and the reducing processing circuit 126 may carry out a filtering process and a sampling process at the second phase, respectively.

Information for generating a high resolution image from low resolution images of a plurality of frames is added to an image including a stationary object by means of the resolution converting process. A motion corresponding to variations may be added to a stationary object, e.g., a change may be added to pixel values included in reduced images of a current frame and a previous frame.

A process in which variations are added may be selectively performed on a block to which the flag setting circuit 113 sets a flag. For example, when a low resolution image is generated from the block indicated with dot meshing in FIG. 3B, variations may be added. A change cycle of variations added to a sampling starting position of a block which detected as being stationary, e.g., a block corresponding to a flag indicating “true” may be set. For example, the variations may be changed at a cycle length which is hardly sensed as a periodic oscillation by human eyes. The change cycle may be controlled so as to fluctuate. When a sequence of high resolution images is restored from a sequence of low resolution images, a periodic oscillation may not be sensed in the sequence of high resolution images.

Dimensions of the added variations (px, py) may be calculated based on a function of the frame number n given by Equation (2). Constants a, b, c, d and e included in Equation (2) may be determined based on a result of simulating a moving image sequence.

(px, py)=a*sin(b*n+c), d*cos(e*n+f) (2)

A function of the frame number and a pixel position before reduction or a block position may be used in addition to the function given in Equation (2) so that the variations (px, py) are determined.

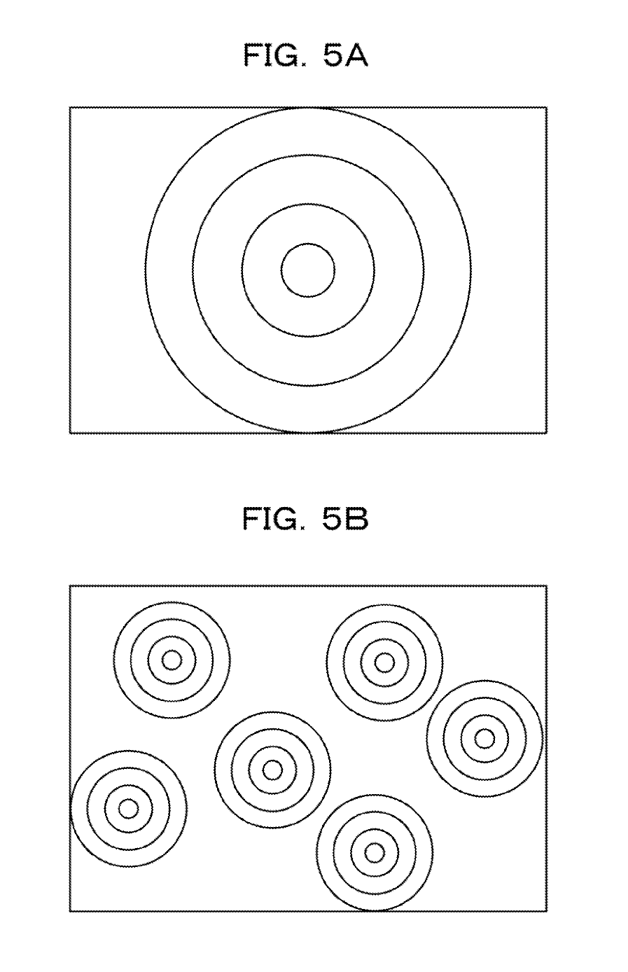

FIGS. 5A and 5B illustrate an exemplary function. The function illustrated in FIG. 5 may be used in order to add variations. FIG. 5A illustrates a function where a value changes from a screen center in concentric circles. FIG. 5B illustrates a function where a plurality of concentric circles are scattered on the screen.

In FIG. 5A, a phase according to the frame number n is set to the function where the value changes in concentric circles so that the variations (px, py) may be determined. In FIG. 5B, he values of the variations (px, py) may be determined by changing the central position of the concentric circular pattern on the screen based on the frame number n or based on the phase according to the frame number n. Amplitudes of values may be attenuated from the center towards the circumference in the concentric circular function.

The variations (px, py) may be determined based on pseudo random numbers having the frame number as a random seed. The variations (px, py) may be generated by using a linear function of the frame number and a pixel position (X, Y). A nonlinear function of the frame number and the pixel position (X, Y) or a function having a hysteresis characteristic may be used. Variations corresponding to an atmospheric fluctuation or an irregular fluctuation such as a camera shake may be calculated by the function.

A sequence of low resolution images includes information for restoring resolution using super-resolution techniques on resorting side. As illustrated in FIG. 3, a block to which variation is added may include details which are easily sensed by human eyes such as edges or textures. Image quality may be improved by restoring resolution by means of super-resolution techniques. A sequence of low resolution images which restores high resolution images having good quality may be generated. As variations are selectively added to some blocks, a sequence of low resolution images may be efficiently compressed.

A filter coefficient set to the first filter may be adjusted so that variations (px, py) are added to a sampling starting position.

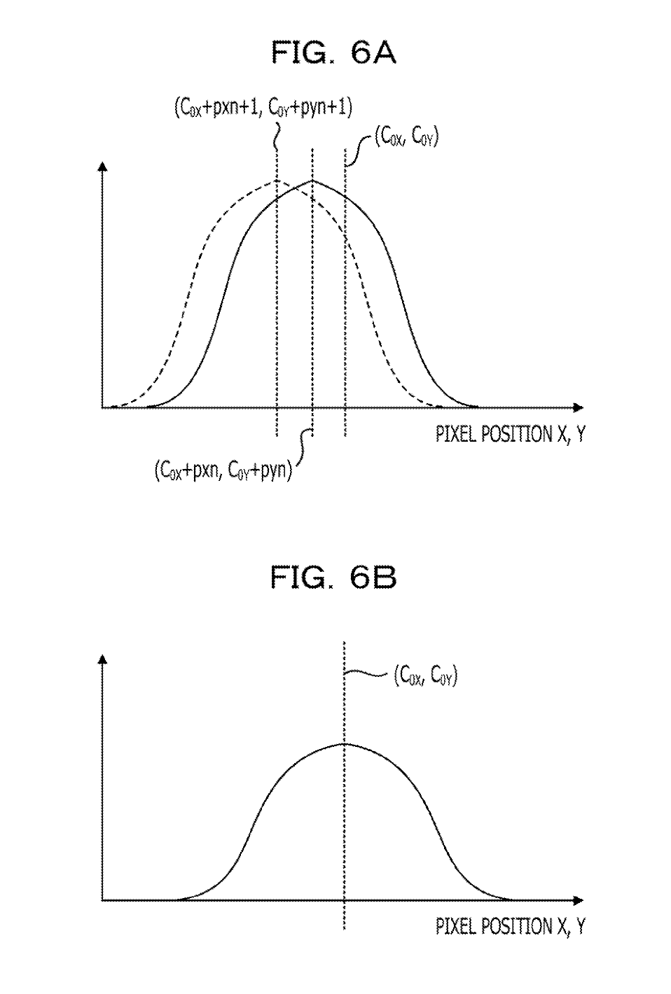

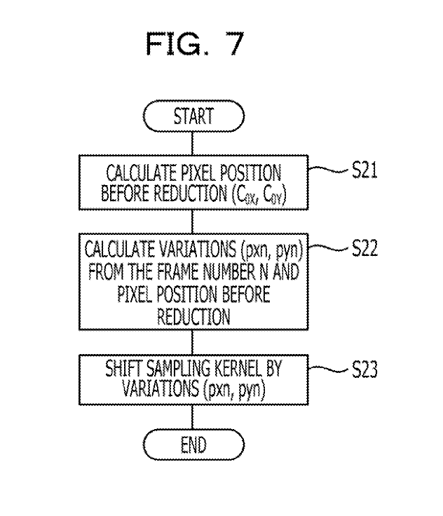

FIGS. 6A and 6B illustrate an exemplary filter coefficient. FIG. 6A illustrates a filter coefficient applied to a block which is detected as being stationary, for example, a bloke corresponding to a flag indicating “true”. FIG. 6B illustrates a filter coefficient applied to a block which is not detected as being stationary, for example, a block corresponding to a flag indicating “false”. FIG. 7 illustrates an exemplary calculation of a filter coefficient.

Coordinates (C_{0X}, C_{0Y}) illustrated in FIGS. 6A and 6B indicate a position of a central pixel of an area of a high resolution image corresponding to a certain pixel of a low resolution image. As illustrated in FIG. 6B, a center of a sampling kernel may coincide with the coordinates (C_{0X}, C_{0Y}) in a filter coefficient of the second filter 123.

A center of a sampling kernel in a filter coefficient indicated by a solid line in FIG. 6A may not coincide with the coordinates (C_{0X}, C_{0Y}). If the filter coefficient indicated in FIG. 6A is applied to a high resolution image and a sampling process is performed, a sampling result may be obtained when variations is added to a sampling start position. In FIG. 6A, a difference between a center position of a sampling kernel of an n-th frame and coordinates (C_{0X}, C_{0Y}) of a center position of a area of a high resolution image corresponding to a certain pixel of a low resolution image is appended to the frame number as a subscript indicated as (pxn, pyn). The solid line indicates a filter coefficient applied to the n-th frame in the first filter 122. The dashed line indicates a filter coefficient applied to the n+1-th frame in the first filter 122.

As illustrated in FIG. 7, coordinates (C_{0X}, C_{0Y}) indicating a center of an area of a high resolution image corresponding to a pixel of a low resolution image is calculated in an operation S21. The filter coefficient calculating circuit 124 illustrated in FIG. 2 may carry out the operation S21. The coordinates (C_{0X}, C_{0Y}) which indicates a position of a pixel representing a portion before reduction may be called as a pixel position before reduction (C_{0X}, C_{0Y}).

The variations (pxn, pyn) are calculated based on the frame number and the pixel position before reduction (C_{0X}, C_{0Y}) in an operation S22. The filter coefficient calculating circuit 124 illustrated in FIG. 2 may carry out the operation S22. A filter coefficient for which the center position of the sampling kernel is shifted by the calculated variations (pxn, pyn) is calculated in an operation S23.

The filter coefficient calculating circuit 124 may calculate the variations (pxn, pyn) by using the function described above. An operation processing circuit of the function may be replaced with a lookup table to which the frame number and/or a pixel position (X, Y) are supplied. The filter coefficient calculating circuit 124 may calculate a filter coefficient by using a sampling kernel that leaves high frequency components which is more than that left by the sampling kernel applied to the second filter 123.

A sequence of low resolution images generated by the resolution converting circuit 120 illustrated in FIG. 2 may be input to the moving image encoding circuit 130 via the low resolution buffer memory 127.

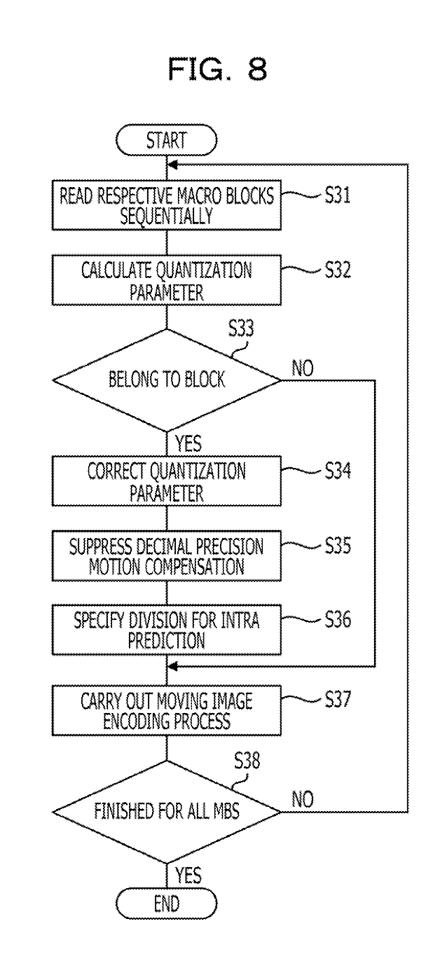

FIG. 8 illustrates an exemplary encoding process. A sequence of low resolution images may be encoded.

A low resolution image of a frame to be encoded is read, e.g., on a macro block basis of 16 pixels times 16 pixels in an operation S31. For example, the moving image encoding circuit 130 illustrated in FIG. 2 may read a macro block. A quantization parameter is calculated in an operation S32. The encoding control circuit 135 illustrated in FIG. 2 may calculate a quantization parameter. The encoding loop circuit 134 may encode a quantization parameter.

In an operation S33, whether a low resolution image included in a macro block does include a pixel of a block of a high resolution image before reduction standing still which is detected as being stationary, e.g., a block corresponding to a flag indicating “true”. For example, the encoding control circuit 135 illustrated in FIG. 2 may detect.

If the macro block includes such a pixel, the process proceeds to operations 34-36. When the resolution converting circuit 120 illustrated in FIG. 2 detects a pixel which is resolution-converted by the first filter 122, the encoding control circuit 135 illustrated in FIG. 2 may carry out the operations S34-S36.

The quantization parameter is corrected in the operation S34. For example, the encoding control circuit 135 illustrated in FIG. 2 may correct the quantization parameter. For example, the quantization parameter set in the operation S32 is corrected so as to become smaller, the encoding loop circuit 134 is provided with the quantization parameter after being corrected, and an encoding process is carried out. The correction of the quantization parameter may contribute to increasing information of a low resolution image generated from an image included in a block which is detected as being stationary, for example, a block corresponding to a flag indicating “true”.

The encoding control circuit 135 instructs the decimal precision inter prediction circuit 132 to reduce a prediction process in an operation S35. The variations added in the resolution converting process may not be cancelled by an inter prediction process of decimal precision. Encoded data may include information concerning a change of a pixel value corresponding to the variations.

For example, the encoding control circuit 135 instructs the intra prediction circuit 133 to make a prediction using a sub block of four pixels times four pixels in an operation S36. The intra prediction circuit 133 may obtain a predicted result including much information.

The operations S34-S36 may be carried out in no particular order. The operations S34-S36 may either entirely or partially be carried out.

A macro block of a low resolution image on which a pixel included in a high resolution image of a block, which is detected as being stationary, for example, a block corresponding to a flag indicating “true”, is reflected is encoded in an operation S37. The encoding loop circuit 134 illustrated in FIG. 2 may encode such a macro block. The macro block may be given lots of codes.

If all pixels of a low resolution image included in a macro block are included in a block, which is detected as not being stationary, for example, a block corresponding to a flag indicating “false” in the operation S33, the process skips the operations S34-S36 and proceeds to the operation S37. A predicted result having a smallest amount of codes may be selected from predicted results of the integer precision inter prediction circuit 131, the decimal precision inter prediction circuit 132 and the intra prediction circuit 133. The encoding loop circuit 134 carries out an encoding process using the quantization parameter calculated in the operation S32.

Each macro block of a low resolution image may be encoded. If all the macro blocks are encoded, the encoding process finishes in an operation S38.

Since the moving image encoding circuit 130 performs an encoding process macro block of a low resolution image on which a pixel included in a high resolution image of a block which is detected as being stationary, for example, a block corresponding to a flag indicating “true”, is reflected is selectively provided with lots of codes. An encoding process of high precision based on the H.264 standard is performed on a portion of the image illustrated in FIG. 3A corresponding to the sky, for example, a featureless portion of the image. Compression efficiency may be enhanced. Encoded data including information for restoring resolution using super-resolution on a restoring side is generated.

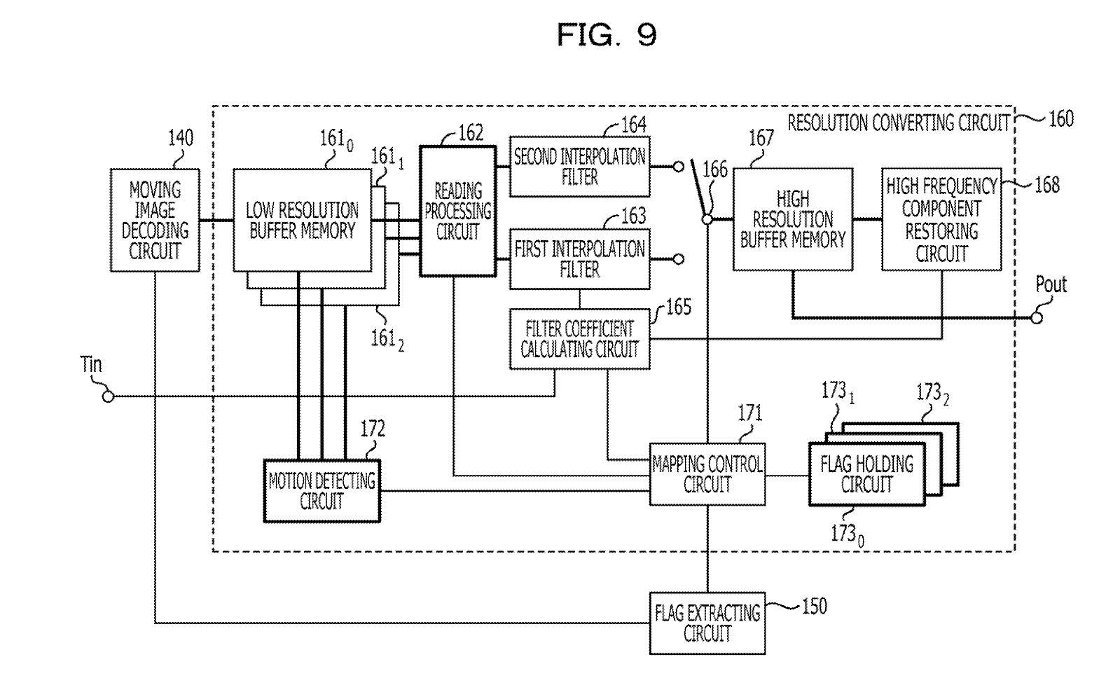

FIG. 9 illustrates an exemplary resolution converting circuit. In FIG. 9, elements which are substantially same as or similar to the corresponding elements illustrated in FIG. 1 are given a same reference numeral, and the explanation may be omitted or reduced.

The resolution converting circuit 160 illustrated in FIG. 9 includes low resolution buffer memories 161₀, 161₁ and 161₂ for three frames. A low resolution image of an n-th, (n-1)-th or (n-2)-th frame may be stored in the low resolution buffer memories 161₀, 161₁ and 161₂. A reading processing circuit 162 reads a low resolution image from the low resolution buffer memory 161₀, 161₁ or 161₂ based on an instruction from a mapping control circuit 171, and provides a first interpolation filter 163 and a second interpolation filter 164 with the low resolution image.

A filter coefficient calculated by a filter coefficient calculating circuit 165 is set to the first interpolation filter 163. The filter coefficient calculating circuit 165 calculates a filter coefficient based on a first interpolation characteristic using the frame number from as instructed by the mapping control circuit 171. A filter coefficient selected based on a second interpolation characteristic which is different from the first interpolation characteristic is set to the second interpolation filter 164.

In FIG. 9, a switch 166 provides a high resolution buffer memory 167 with outputs of the first interpolation filter 163 or of the second interpolation filter 164 selectively upon an instruction from the mapping control circuit 171. A pixel value obtained by the first interpolation filter 163 or by the second interpolation filter 164 is supplied to the high resolution buffer memory 167 via the switch 166, and is mapped onto a position corresponding to a high resolution image obtained by the interpolation process.

The resolution converting circuit 160 illustrated in FIG. 9 includes a high frequency component restoring circuit 168. The high frequency component restoring circuit 168 restores a high frequency component base on high resolution image data stored in the high resolution buffer memory 167 using an unsharp masking process or another process. Known techniques may be applied to an unsharp masking process or another process. The high resolution buffer memory 167 is provided with a high resolution image via the output port Pout.

A motion detecting circuit 172 included in the resolution converting circuit 160 illustrated in FIG. 9 detects a motion between a low resolution image of a current frame and a certain reference image in response to an instruction from the mapping control circuit 171. Flag data, which is extracted from stream data by the flag extracting circuit 150, is stored in one of flag holding circuits 173₀, 173₁ and 173₂ via the mapping control circuit 171. Flag data extracted from stream data of a current frame may be maintained until a completion of the resolution converting process on an (n+2)-th frame which appears by two frames behind an completion of the resolution converting process on the current frame.

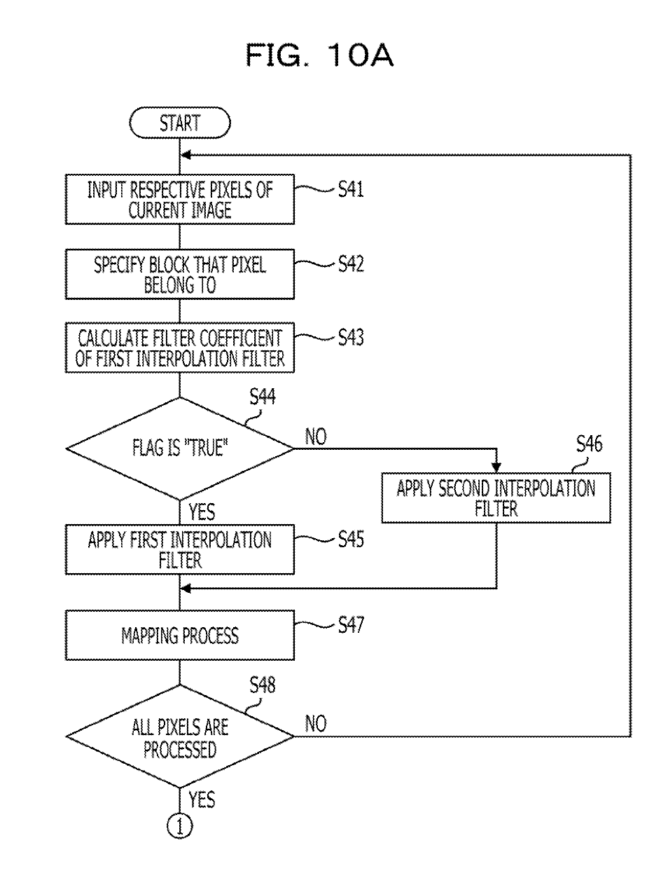

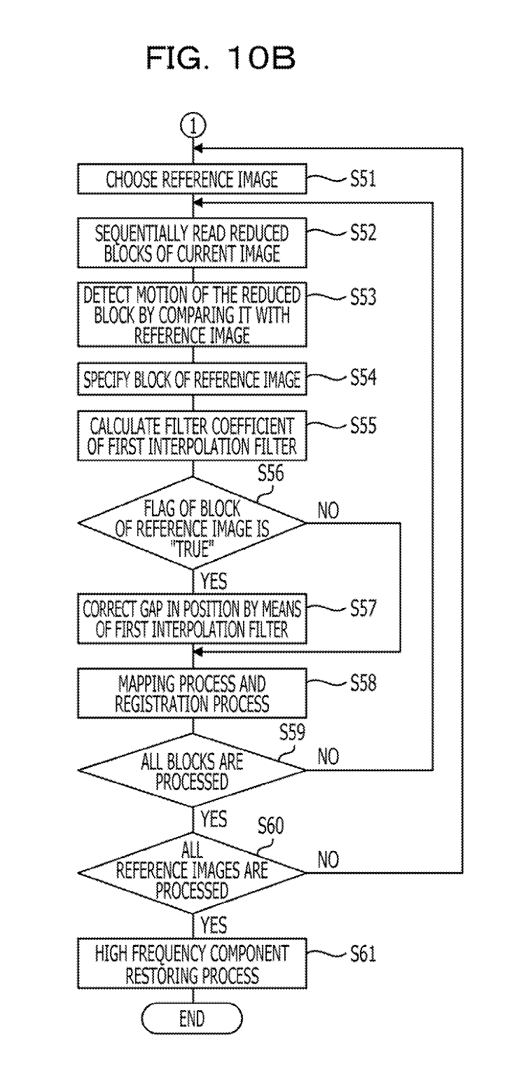

FIGS. 10A and 10B illustrate an exemplary resolution converting process. In FIGS. 10A and 10B, a low resolution image is converted into a high resolution image. Pixel data included in a current image is mapped onto a high resolution image. Mapping and registration processes are carried out using a reference image and a current image. A terminal 1 in FIG. 10A is coupled to a terminal 1 illustrated in FIG. 10B.

Pixels of a current image are sequentially read in an operation S41 illustrated in FIG. 10A. The reading processing circuit 162 illustrated in FIG. 9 may read a pixel of a current image from the low resolution buffer memories 161₀. The first interpolation filter 163 and the second interpolation filter 164 illustrated in FIG. 9 may be provided with a pixel value and position data of the pixel.

In an operation S42, a block of a high resolution image including a pixel before reduction is specified based on position data of a low resolution image. The mapping control circuit 171 illustrated in FIG. 9 may specify a block of a high resolution image including a pixel before reduction based on position data of the read pixel. In an operation S43, a filter coefficient of the first interpolation filter 163 is calculated. The filter coefficient calculating circuit 165 illustrated in FIG. 9 may calculate a filter coefficient to be set to the first interpolation filter based on the frame number of a current frame and position data of a pixel.

In an operation S44, whether the block specified in the operation S42 is detected as being stationary or not, for example, a flag of the block is “true” or not is detected. The mapping control circuit 171 illustrated in FIG. 9 may detect whether the flag of the specified block is “true” with reference to a flag holding circuit 173₀ corresponding to the current frame.

If a pixel of a current image is included in a block which is detected as being stationary before reduction, e.g., a block corresponding to a flag indicating “true”, the switch 166 selects an output of the first interpolation filter 163. In operations S45 and S47, the pixels of the current frame input in the operation S41 are mapped onto the high resolution buffer memory 167 via the first interpolation filter 163.

If a pixel of a current image is not included in a block which is detected as being stationary, e.g., a block corresponding to a flag indicating “true”, the pixel of the current image is detected as being included in a block which is not detected as being stationary before reduction, e.g., a block corresponding to a flag indicating “false”, and the switch 166 selects an output of the second interpolation filter 164. In operations S46 and S47, the pixels of the current image input in the operation S41 are mapped onto the high resolution buffer memory 167 via the second interpolation filter 164.

The above operations may be repeated for all pixels included in the current image. When all pixels are completely processed in an operation S48, a generation of a high resolution image where the current image is mapped is completed. A super-resolution process using a reference image may start.

In an operation S51 illustrated in FIG. 10B, the mapping control circuit 171 selects one of two reference images. The mapping control circuit 171 may select a reference image in order from (n-1)-th to (n-2)-th frames or vice versa.

In an operation S52, the motion detecting circuit 172 sequentially reads a current image of a block of a high resolution image from the low resolution buffer memory 161₀. The current image read in the operation S52 may correspond to a low resolution image generated by reducing a block of a high resolution image. A portion of a low resolution image corresponding to a block of a high resolution image may be referred as a block of a low resolution image. In an operation S53, the motion detecting circuit 172 compares the block of the current image read from the low resolution buffer memory 161₀ and the reference image selected in the operation S51 so as to detect a motion of the block of the current image.

In an operation S54, the mapping control circuit 171 specifies a block of a reference image corresponding to the block of the current image based on a result detected by the motion detecting circuit 172. The mapping control circuit 171 may supply data for specifying a block of a reference image to the reading processing circuit 162 and the filter coefficient calculating circuit 165. The first interpolation filter 163 and the second interpolation filter 164 are provided with a block of a reference image corresponding to the chosen reference image, which is stored in the low resolution buffer memory 161, via the reading processing circuit 162. In an operation S55, the filter coefficient calculating circuit 165 calculates a filter coefficient based on position data indicating the specified reference image and the frame number of the reference image.

The mapping control circuit 171 refers to a flag holding circuit 173 corresponding to the selected reference image so as to obtain a flag corresponding to the block of the reference image specified in the operation S54.

If the flag indicates “true”, the mapping control circuit 171 detects that the block of the specified reference image is compressed by the data compression device as a block which is detected as being stationary, e.g., a block corresponding to a flag indicating “true”. The switch 166 selects an output of the first interpolation filter. In an operation S57, the first interpolation filter 163 corrects a pixel included in the block of the reference image specified in the operation S54 based on the position data which is added to the pixel when compressing data of the reference image. In an operation S58, a correction result is reflected on an operation where a pixel included in the block of the reference image is mapped onto a high resolution image or a registration operation. Resolution of a super-resolution process may be improved by using data of variations which are added when generating the reference image and the current image.

If the flag value indicates “false”, the mapping control circuit 171 may detect that the block of the specified reference image is compressed as a block which is detected as not being stationary, e.g., a block corresponding to a flag indicating “false”. The switch 166 selects an output of the second interpolation filter 164. The high resolution buffer memory 167 is provided with the output of the second interpolation filter 164. In an operation S58, a mapping process and a registration process are performed on a pixel of a block of the reference image specified in the operation S54.

Every time a mapping process on a block of a current image finishes in an operation S59, the mapping control circuit 171 detects whether all blocks of the current image are processed or not. When all blocks are not processed, the process returns to the operation S52 and the mapping control circuit 171 instructs the motion detecting circuit 172 to process a new block. When all the blocks included in the current image are completely processed, the process proceeds to an operation S60.

In an operation S60, the mapping control circuit 171 detects whether all the reference images are processed or not. When all reference images are not processed, the process returns to the operation S51 and the mapping control circuit 171 selects and processes a new reference image. When the mapping and registration processes are performed on all the reference images stored in the low resolution buffer memory 161, the high frequency component restoring circuit 168 carries out a process based on an instruction from the mapping control circuit 171 in an operation S61.

Resolution of a stationary object including details for which degradation of image quality is perceptible when replaying a moving image may be improved by means of a super-resolution process using data included in a plurality of reference images.

Another compression process is performed on a block which is detected as not being stationary and corresponds to a portion including an object which moves in a frame included in a sequence of a high resolution image or a portion including an object which does not have lots of details e.g., a block corresponding to a flag indicating “false”. For example, an ordinary compression process may be carried out. Since a current image and two reference images are mapped onto the high resolution buffer memory 167 via the second interpolation filter 164, resolution of the portion including a moving object may be improved. Degradation of image quality of the portion including an object which does not have lots of details may be imperceptible for human eyes.

Moving image data is compressed highly efficiently. A moving image of high quality may be replayed from recorded compressed data. Since a lot of moving image data are compressed and recoded using effectively an capacity of a recording medium such as a hard disk device, a quality of a replayed image may be improved. A transcoder including a data compression device and a data restoring device may be applied to an image recording device for broadcasting of a stationary type or a movie camera of a handheld type.

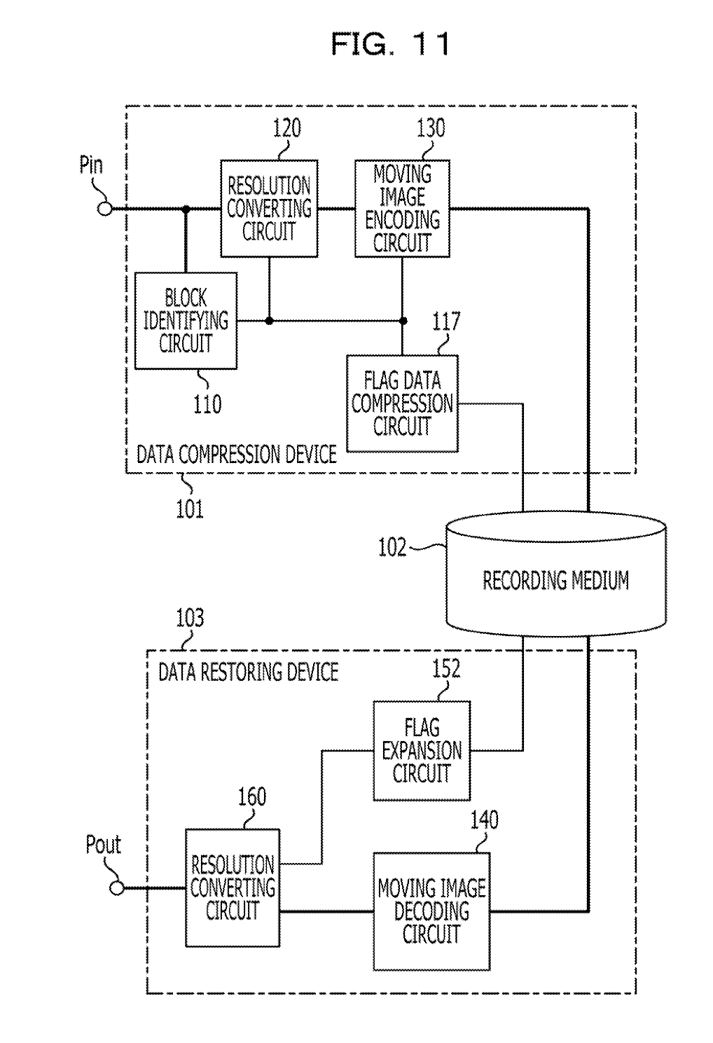

In a transcoder including a data compression device and a data restoring device, the data compression device provides the data restoring device with flag data embedded in stream data. FIG. 11 illustrates an exemplary data compression device and an exemplary data restoring device. In FIG. 11, elements which are substantially same as or similar to the elements illustrated in FIG. 1 are given a same reference numeral, and the explanation may be omitted or reduced.

A data compression device 101 illustrated in FIG. 11 includes a flag data compression circuit 117. The data compression device 101 may not have a flag overlay circuit 136. For example, the flag data compression circuit 117 carries out a Huffman encoding process on flag data regarding a flag of a block set by a block identifying circuit 110, so as to generate compressed flag data. For example, the compressed flag data may be associated to moving image encoded data generated by the moving image encoding circuit 130, and stored in a recording medium 102.

A data restoring device 103 illustrated in FIG. 11 may include a flag expansion circuit 152 instead a flag overlay circuit 136. The data restoring device 103 may not include the flag overlay circuit 136 illustrated in FIG. 1. The flag expansion circuit 152 decodes compressed flag data read from the recording medium 102. The decoded flag data is provided to a resolution converting circuit 160.

Flag data may be compressed and recorded independent from stream data generated by encoding a sequence of low resolution images, and the compressed flag data may be read from the recording medium independent from the stream data on a restoring side.

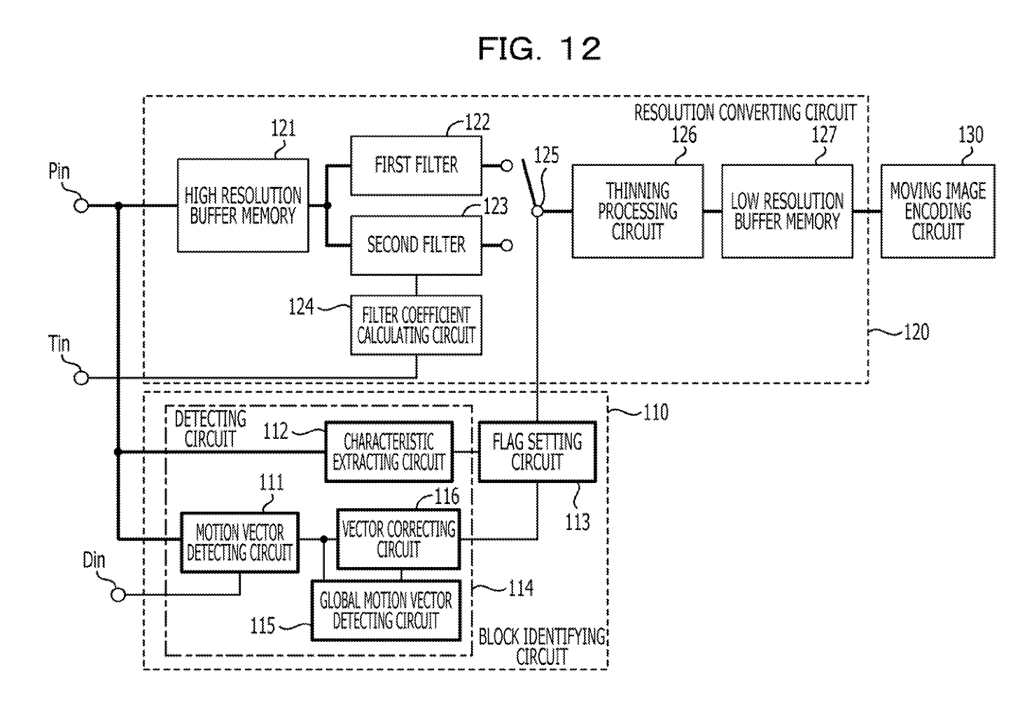

A block to be resolution-converted in a first reduction process and be detected as being stationary, for example, a block corresponding to a flag indicating “true”, may be precisely detected. FIG. 12 illustrates an exemplary block detecting circuit. In FIG. 12, elements which are substantially same as or similar to the elements illustrated in FIG. 2 are given a same reference numeral, and the explanation may be omitted or reduced.

The block identifying circuit 110 illustrated in FIG. 12 includes a global motion vector detecting circuit 115 and a vector correcting circuit 116 in a detecting circuit 114. The global motion vector detecting circuit 115 illustrated in FIG. 12 detects a global motion vector corresponding to a motion of an entire screen based on a motion vector detected by a motion vector detecting circuit 111. The vector correcting circuit 116 may correct a motion vector detected by the motion vector detecting circuit 111 using a global motion vector. The vector correcting circuit 116 may calculate a differential vector between a motion vector of a block and a global motion vector for correction. A flag setting circuit 113 may detect a standstill property of an object included in a block based on a differential motion vector of each of blocks.

A block which is detected as being stationary, e.g., a block corresponding to a flag indicating “true”, is detected based on a differential vector so that a standstill property of an object may be detected regardless of a motion of an entire screen such as a pan operation of a camera. A block having details and including a stationary object may be precisely detected from a frame image.

If a data compression device is applied to a movie camera of a handheld type, a global motion vector may be calculated based on data coming from an accelerometer of the movie camera.

Example embodiments of the present invention have now been described in accordance with the above advantages. It will be appreciated that these examples are merely illustrative of the invention. Many variations and modifications will be apparent to those skilled in the art.

1. A data compression method comprising:
dividing image data corresponding to one frame into a plurality of blocks;
detecting a motion vector of a first block of the plurality of blocks;
setting a flag to the first block based on the motion vector;
performing a first reduction process on the first block; and
performing a second reduction process on a second block of the plurality of blocks.

2. The data compression method according to claim 1, wherein:
the first reduction process includes a filtering process having a first transmission characteristic; and
the second reduction process includes a filtering process having a second transmission characteristic which is different from the first transmission characteristic.

3. The data compression method according to claim 1, wherein:
the first reduction process includes a sampling process at a first phase; and
the second reduction process includes a sampling process at a second phase which is different from the first phase.

4. The data compression method according to claim 1, wherein the flag is set to the first block based on an edge component of the image data and a standstill property of the first block detected based on the motion vector.

5. The data compression method according to claim 4, wherein the flag is set to the first block based on brightness of the first block.

6. The data compression method according to claim 1, further comprising:
performing a compression process on the first block using a first quantization parameter; and
performing a compression process on the second block using a second quantization parameter which is larger than the first quantization parameter.

7. The data compression method according to claim 1, wherein the flag is not set to the second block.

8. A data compression device comprising:
a dividing circuit to divide image data corresponding to one frame into a plurality of blocks;
a detecting circuit to detect a motion vector of a first block of the plurality of blocks;
a flag setting circuit to set a flag to the first block based on the motion vector; and
a reduction circuit to perform a first reduction process on the first block and perform a second reduction process on a second block of the plurality of blocks.

9. The data compression device according to claim 8, wherein the reduction circuit includes:
a first filter including a first transmission characteristic; and
a second filter including a second transmission characteristic which is different from the first transmission characteristic.

10. The data compression device according to claim 8, further comprising,
a compression circuit to compress the first block on which the first reduction process is performed and the flag corresponding to the first block.

11. The data compression device according to claim 8, further comprising,
a compression circuit to compress the flag.

12. The data compression device according to claim 8, wherein:
the detecting circuit detects an edge component of the image data and a standstill property of the block based on the motion vector; and
the flag is set to the first block based on the edge component and the standstill property.

13. The data compression device according to claim 8, wherein the detecting circuit includes:
a global motion vector detecting circuit to detect a global motion vector of the image data; and
a vector correcting circuit to correct a motion vector of at least one of the plurality of blocks based on the global motion vector.

14. The data compression device according to claim 8, wherein the flag is not set to the second block.

15. A data compression device comprising:
a first detecting circuit to detect a first motion vector of image data corresponding to one frame;
a dividing circuit to divide the image data into a plurality of blocks;
a second detecting circuit to detect a second motion vector of a first block of the plurality of blocks;
a flag setting circuit to set a flag to the first block based on the first motion vector and the second motion vector; and
a reduction circuit to perform a first reduction process on the first block and perform a second reduction process on a second block of the plurality of blocks.

16. The data compression device according to claim 15, wherein the flag is not set to the second block.
